(19) United States
(12) Patent Application Publication
(10) Pub. No.: US 2010/0149815 A1
(43) Pub. Date: Jun. 17, 2010

(54) REMOTE LIGHTING ASSEMBLIES AND METHODS

(75) Inventor: Alexei A. Erchak, Cambridge, MA (US)

Correspondence Address: LUMINUS DEVICES , INC.;C/O WOLF, GREENFIELD & SACKS , P.C., 600 ATLANTIC AVENUE, BOSTON, MA, 02210-2206, US

(73) Assignee: Luminus Devices, Inc., Billerica, MA (US)

(21) Appl. No.: 12/580,395

(22) Filed: Oct. 16, 2009

Related U.S. Application Data
(60) Provisional application No. 61/106,296, filed on Oct. 17, 2008.

(51) Int. Cl. F21V 9/00; F21V 3/00; F21V 7/00

(52) U.S. Cl. 362/293; 362/311.02; 362/296.01

(57) ABSTRACT

Lighting assemblies and methods are described. In some embodiments, the lighting assembly includes a light-emitting device and a luminaire. The light-emitting device may be an LED.

### RELATED APPLICATIONS

This application claims priority to U.S. Provisional Application No. 61/106,296, filed Oct. 17, 2008, which is incorporated herein by reference in its entirety.

### FIELD

The present embodiments are drawn generally towards lighting assemblies, and more specifically, lighting assemblies including light-emitting devices.

### BACKGROUND

Lighting assemblies can provide light for a variety of applications, including general lighting and electronic applications. Currently most lighting assemblies mainly employ incandescent and fluorescent light sources. Incandescent bulbs are inexpensive, but have very low energy efficiency and short lifetimes. Fluorescent tubes can provide efficient distributed lighting, but have serious disadvantages including complicated inverter electronics, slow switching speeds, and the presence of hazardous materials within the fluorescent tubes such as mercury. Light-emitting devices, such as light-emitting diodes, can provide for efficient and environmentally safe lighting.

A light-emitting diode (LED) can provide light in a more efficient manner than an incandescent and/or a fluorescent light source. The relatively high power efficiency associated with LEDs has created an interest in using LEDs to displace conventional light sources in a variety of lighting applications. For example, in general area lighting applications LED lights offer benefits such as small size, long lamp life, low heat output, energy savings and durability. Using LEDs in general area lighting application can allow adding new functionality which may be difficult to achieve using conventional lighting technology. For example, LEDs can be used for color mixing and color control. LED light is generally a less flammable source of light, which makes it a safer choice in home lighting applications.

Typically, an LED is formed of multiple layers, with at least some of the layers being formed of different materials. In general, the materials and thicknesses selected for the layers influence the wavelength(s) of light emitted by the LED. In addition, the chemical composition of the layers can be selected to promote isolation of injected electrical charge carriers into regions (e.g., quantum wells) for relatively efficient conversion to light. Generally, the layers on one side of the junction where a quantum well is grown are doped with donor atoms that result in high electron concentration (such layers are commonly referred to as n-type layers), and the layers on the opposite side are doped with acceptor atoms that result in a relatively high hole concentration (such layers are commonly referred to as p-type layers).

LEDs also generally include contact structures (also referred to as electrical contact structures or electrodes), which are conductive features of the device that may be electrically connected to a power source. The power source can provide electrical current to the device via the contact structures, e.g., the contact structures can deliver current along the lengths of structures to the surface of the device within which light may be generated.

### SUMMARY

Lighting assemblies and methods associated therewith are provided.

In one aspect, a general lighting assembly can contain a single lambertian surface emitting device that is a single semiconductor light-emitting diode and is configured to substantially illuminate a maximized volume of space.

In another aspect, an indirectly illuminated general lighting assembly includes a single lambertian surface emitting device and a luminaire capable of spatially distributing light to cover an even more extensive volume of space.

In another aspect, a general lighting assembly is provided. The assembly comprises a semiconductor-based light-emitting device; and a luminaire separated from and in optical communication with the light-emitting device configured to receive and to transmit light emitted by the light-emitting device to an emission surface of the luminaire through which light is emitted.

In one aspect, optical illumination routing assemblies allow for light from a single light-emitting device to be remotely transmitted and distributed from a light output port a distance away from the light source.

In another aspect, optical illumination routing assemblies can contain cylindrical light guides that transmit light to output ports.

In another aspect, the cylindrical light guides may also contain wavelength converting material components that absorb the light emitted from the output end of the light guide and retransmit as a second light.

In one aspect, multiple cylindrical light guides can be connected to one light source substantially increasing the volume of space a single light source can illuminate.

In another aspect, multiple cylindrical light guides connected to one light source can contain multiple wavelength converting material components at the ends of each of the light output ends of the multiple cylindrical light guides.

In another aspect, multiple cylindrical light guides connected to one light source can contain multiple light guides at the ends of each of the light output ends of the multiple cylindrical light guides that have light extraction and light distribution features.

Other aspects, embodiments and features of the invention will become apparent from the following detailed description of the invention when considered in conjunction with the accompanying figures. The accompanying figures are schematic and are not intended to be drawn to scale. Each identical or substantially similar component that is illustrated in various figures is represented by a single numeral or notation.

For purposes of clarity, not every component is labeled in every figure. Nor is every component of each embodiment of the invention shown where illustration is not necessary to allow those of ordinary skill in the art to understand the invention. All patent applications and patents incorporated herein by reference are incorporated by reference in their entirety. In case of conflict, the present specification, including definitions, will control.

### BRIEF DESCRIPTION OF FIGURES

FIG. 1 is a perspective view of a single lambertian surface emitting device illuminating a volume of space, in accordance with one embodiment;

FIG. 2A is a perspective view of an indirectly illuminated general lighting assembly that includes a luminaire, in accordance with one embodiment;

FIG. 2B is a perspective view of a single surface a single lambertian surface emitting device, in accordance with one embodiment;

FIG. 3 is a perspective view of an optical illumination routing assembly that emits light remotely from the light emitting device using a cylindrical light guide, in accordance with one embodiment;

FIG. 4 is a perspective view of an optical illumination routing assembly that includes wavelength converting material components at the light output end of the cylindrical light guide, in accordance with one embodiment;

FIG. 5 is a perspective view of an optical illumination routing assembly that includes a cylindrical light guide that remotely lights a second light guide, in accordance with one embodiment;

FIG. 6 is a perspective view of an optical illumination routing assembly that is used to remotely light a vertical display panel, in accordance with one embodiment;

FIG. 7 is a perspective view of an illumination system for a computer display that includes a fanned light spatial homogenizer as part of a display neck, in accordance with one embodiment;

FIG. 8 is a perspective view of an optical illumination routing assembly that includes multiple cylindrical light guides, in accordance with one embodiment;

FIG. 9 is a perspective view of an optical illumination routing assembly that includes wavelength converting material components at each of the light output ends of the multiple cylindrical light guides in FIG. 8, in accordance with one embodiment;

FIG. 10 is a perspective view of an optical illumination routing assembly that includes multiple cylindrical light guides arranged to illuminate a maximized volume of space, in accordance with one embodiment;

FIG. 11 is a perspective view of an optical illumination routing assembly that includes light guides at each of the light output end of the multiple cylindrical light guides arranged as in FIG. 10, in accordance with one embodiment;

FIG. 12 a perspective view of an optical illumination routing assembly that includes light output ports configured to extract light and arranged linearly along the length of the light guide, in accordance with one embodiment;

FIG. 13 is a perspective view of a light-emitting device, in accordance with one embodiment.

### DETAILED DESCRIPTION

Large-chip light emitting devices can be designed to replace high-intensity lamps or small chip arrays with a very large single chip (e.g., greater than about 1 mm² emission area, greater than about 3 mm² emission area, greater than about 6 mm² emission area, greater than about 12 mm²) for applications requiring ultra-high lumen point sources. For general illumination, conventional small chip light emitting devices may be desirable for their high efficacy and color changing capability, but low lumen output per lamp continues to be an issue. The increasingly maligned 100 W incandescent lamp can produce around 1700 lm (and with ideal color rendering and a desirable color temperature). By contrast, even the best white power LEDs (approximately 100 lm/W) only produce 100 lumens of relatively inferior light (poorer color rendering with high color temperature). In conventional systems, to reach lumen levels desired for general illumination, many LED chips or lamps are typically combined in arrays.

Large-chip light emitting devices for general illumination can comprise a single lambertian surface emitting device. Lambertian emitters follow Lambert's cosine law. Lambert's cosine law in optics says that the radiant intensity observed from a “Lambertian” surface is directly proportional to the cosine of the angle θ between the observer's line of sight and the surface normal. The result of which is when such a surface is viewed from any angle, it has the same apparent radiance. The benefit of using such a source for general lighting application can be seen from the much more efficient radiance pattern. Unlike a conventional light source, a lambertian light source reduces the amount of light absorbed by the planner surface on which the lambertian light source is located. For example, if a lambertian light source is located on the ceiling of a room, the majority of the light is directed downward, reducing the amount of light absorbed by the ceiling.

General lighting assemblies presented herein can include a single lambertian surface emitting device such as single semiconductor light-emitting diode and/or a single laser diode. These single lambertian surface emitting devices can serve as high brightness compact light sources for a variety of applications. Since lambertian surface emitting devices are typically compact light sources, for applications where distributed volume of light is desired, light emitted by the light-emitting devices can be incorporated into a general lighting assembly that can redirect and emit light via configurations that can extend light emission. These configuration could produce a volume of light substantially greater than the emission volume of light out of a single lambertian surface emitting device (e.g., greater than about 100 times, greater than about 500 times, greater than about 1000 times, greater than about 2000 times).

Some embodiments presented herein can accomplish such redirection and emission of light from these lambertian surface emitting devices and can provide for distributed illumination via an extended light emission configuration. In some embodiments, during the process of light redirection and/or emission, some or all of the light from the lambertian surface emitting devices may be wavelength converted. Wavelength conversion of some or all of the light can facilitate redirection and/or emission of the light from the illumination assembly.

Some embodiments presented herein include illumination assemblies that can emit primary light having a first wavelength spectrum and a wavelength converting material (e.g., phosphors and/or quantum dots) that can covert the primary light to secondary light having a different wavelength spectrum (e.g., down-convert the primary light to a lower energy). As used herein, a wavelength converting material refers to a material that can absorb some or substantially all of the primary light having a first wavelength spectrum (e.g., blue light, UV light) and emit secondary light having a second different wavelength spectrum (e.g., white light, yellow light, red light, green light, and/or blue light). The wavelength converting material can down-convert light from shorter wavelengths (higher energies) to longer wavelengths (shorter energies). Phosphor materials are examples of typical wavelength converting materials, which can take the form of phosphor particles. Quantum dots can also serve as wavelength converting materials.

In some embodiments presented herein, the wavelength converting material can have a density that differs in different locations. The density of wavelength converting material per unit area is the amount of wavelength converting material per averaging area disposed above and underneath an averaging area of 1×1 cm². For example, in some embodiments, the averaging area can be located on the emission surface of an illumination assembly, and in such cases, the density is referred to as the density of wavelength converting material per unit area of the emission surface. Such an averaging area excludes variations of wavelength converting material density at the package level of a light-emitting device, for example, variations of wavelength converting material density within an encapsulant layer of a light-emitting device.

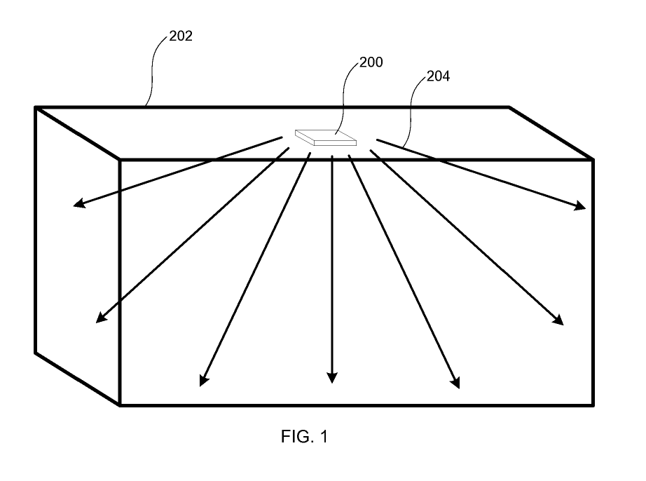

FIG. 1 illustrates a single light-emitting device illuminating a volume of space, in accordance with one embodiment. In some cases, the light-emitting device is a lambertian surface light-emitting device. The light emitting device 200 can emit light 204 that can substantially illuminate a volume of space 202. The light emission volume that the light-emitting device can substantially illuminate may be greater than about 10 m³ (e.g., greater than or equal to about 15 m³, greater than or equal to about 25 m³, greater than or equal to about 35 m³). However, it should be understood that the emission volume of space that the light-emitting device can illuminate herein is not limited to the above-described volume figures. In some embodiments, a plurality of light-emitting devices, similar to the lambertian device 200, can be arranged adjacent each other (e.g., tiled along either one or two dimensions) to form a combined illumination assembly having a combined light emission surface (e.g., adjacent light emission surfaces that can tile a surface, such as a plane).

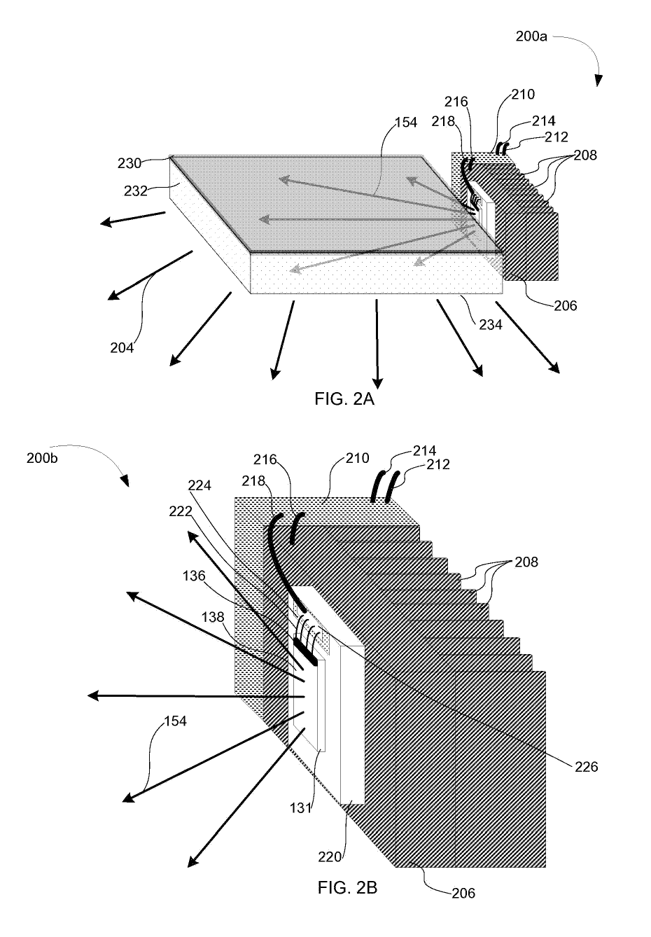

FIG. 2A illustrates an indirectly illuminated general lighting assembly that includes a luminaire, in accordance with one embodiment. Illumination assembly 200a can include a light emitting device 200b and a luminaire 232. A luminaire is an optical fixture that transmits and distributes directional light from a single light source to a significantly more extensive volume of space. Although the illumination assembly illustrated in FIG. 2A is edge-lit by the light emitting device, alternatively or additionally, a general lighting assembly can be back-lit by the light emitting device.

As shown, the light emitting device may be separate from the luminaire. That is, the light emitting device and the luminaire are separate component. In some embodiments, and as shown, the light emitting device may be adjacent the luminaire. For example, the emission surface of the light emitting device may be in contact with a light receiving surface of the luminaire. In other embodiments, the emission surface of the light-emitting device may be separated from the light receiving surface of the luminaire by a distance.

In some embodiments, it may be preferred for the light emitting device to be an LED as described further below. In some cases, it may be preferable for the light emitting device to be a single light emitting device such as a single LED die.

In one embodiment, light 154 (referred to as primary light) emitted by the device 200b may be coupled into a light mixing region (not shown), luminaire 232 or a combination of both. A light mixing region can blend the light emitted out of the light emitting device such that light emitted 204 has substantially uniform color on different locations of the light output boundary 234.

Light mixing region may comprise a light guide or a wave guide having a higher index than a surrounding medium. The light guide can include an edge configured to receive the light emitted by the device 200b. For example, light mixing region may include part or all of a light guide formed of an optically transparent material such as transparent plastic (e.g., PMMA, acrylic) and/or glass. The light guide can have any suitable shape. In some embodiments, the light guide has a slab shape (e.g., rectangular slab, square slab, trapezoidal slab) and/or other suitable light guiding shapes.

Light 154 may be coupled to a luminaire 232. Luminaire 232 can include a light emission surface 234 through which light 154 can be emitted. The emission surface of the luminaire may be substantially perpendicular to the general direction of the light 204 leaving the luminaire 232. Alternatively or additionally the light 204 leaving the luminaire may be at any angle in relation to the light emission surface.

The luminaire 232 can include light extraction features that can scatter light out via the light emission surface 234. Luminaire 232 may include one or more components composed of material(s) that can transmit, diffuse, homogenize, and/or emit some or all of the light transmitted therein. In some embodiments, luminaire 232 may include scattering centers that can diffuse, scatter, homogenize, and/or emit some or all of the light transmitted therein so that light may exit along some or all of the length of the luminaire 232. Luminaire 232 may contain a reflective layer 230 that can reflect light downward and away from the top surface of the luminaire 232. In some embodiments, luminaire 232 can be configured and arranged such that light emission from the emission surface 234 has a substantially uniform (e.g., less than about 20% variation, less than about 15% variation, less than about 10% variation) light intensity across the emission surface 234.

Examples of suitable luminaires can include light guides, panels, lamps and fixtures. Other luminaires are also possible. In some embodiments, the luminaire may have a cylindrical shape; in other embodiments a planar shape. Other shapes are also possible.

In a preferred embodiment, the light mixing region may not be needed. The light extracted out of the light emitting device may be already the desired color and may not require blending of multiple color lights. In such an embodiment, light 154 outputted by the light emitting surface 136 may be coupled directly to luminaire 232. Luminaire 232 can include a light emission surface 234 through which light 204 can be emitted.

The light emission surface of the luminaire is separated from the light emission surface of the light-emitting device. For example, a distance between a light emission surface of the light-emitting device and the emission surface of the luminaire is at least 5 inches; in some embodiments, at least 15 inches; and, in some embodiments, at least 35 inches; and, in some embodiments, at least 70 inches.

In some embodiments, luminaire 232 may comprise a light guide or a wave guide. Light extraction features may be located in the light guide volume and/or on the top and/or bottom surfaces of the light guide. The number of extraction features may vary along the length of the light guide so as to ensure that light emission via the light emission surface is substantially uniform along the length of the light guide. In some embodiments, the intensity variation of light emitted along the length of the light guide is less than about 20% (e.g., less than about 15%, less than about 10%, less than about 5%). In some embodiments, luminaire 232 may include part or all of a light guide formed of an optically transparent material such as glass or a plastic material (e.g., acrylic, PMMA).

The general lighting assembly 200a can include wavelength converting material in one or more locations within the luminare 232, such as one or more phosphors and/or one or more types of quantum dots. The wavelength converting material can absorb and convert primary light having a first wavelength spectrum to secondary light having a second wavelength spectrum different from the first wavelength spectrum. In some embodiments, the wavelength converting material can down-convert light having higher energy (e.g., shorter wavelengths) to light having lower energy (e.g., longer wavelengths). For example, the wavelength converting material can down-convert blue and/or ultraviolet light to longer wavelength light, such as red, green, yellow, or blue light, or combinations thereof. White light can be created with a combination of multiple colors, for example, blue and yellow, or blue, green, and red. Thus, one method of forming white light using a wavelength converting material can include down-converting some blue primary light to yellow and forming white light with a combination of secondary yellow light and unconverted primary blue light. Another method of forming white light includes down-converting some primary blue light to red and green light, for example using two or more different wavelength converting materials (e.g., a red-emitting and a green-emitting wavelength converting material). Another method of forming white light includes down-converting ultraviolet light to red, green, and blue light, for example using two or more different wavelength converting materials (e.g., a red-emitting, a green-emitting, and a blue-emitting wavelength converting material).

In some embodiments, wavelength converting material is disposed within mixing region. The presence of wavelength converting material in the lighting assembly can facilitate the process of mixing and/or extraction of light from the illumination assembly (e.g., via the light emission surface 234). The wavelength converting material may be located within part or all of the mixing region such that some or all of the primary light from light-emitting device 154 may be wavelength converted within the mixing region. The process of wavelength conversion can facilitate light homogenization since primary light 154 traveling in a given direction based on the arrangement of the light-emitting device 200b can be absorbed by the wavelength converting material and secondary light can be re-emitted in any other direction with equal probability. This can also allow for a decrease in the length of the mixing region used to provide for a substantially uniform light at light output boundary 234. The placement of the wavelength converting material in the mixing region can provide for the output of secondary light from the mixing region, or a combination of secondary and primary light.

In other embodiments, the wavelength converting material is disposed on the surface of the light emitting device. Wavelength converting material disposed on the light emitting device can result in light from surface the light emitting device to be substantially mixed and of a desired color. Such placement may not require a mixing region and may allow for the lambertian device 200b to be directly coupled to the luminaire 232. In such an embodiment, the wavelength converting material may be disposed within the luminaire 232. The wavelength converting material may be located within part or all of the luminaire 232 such that some or all of the primary light from light-emitting device 154 may be wavelength converted within the luminaire 232.

In some embodiments, the wavelength converting material may be uniformly distributed throughout the any of the light regions. In other embodiments, the wavelength converting material may have a varying density for at least two locations in the regions. For example, the density of wavelength converting material can be highest at the light output boundary 234. Alternatively, the density of wavelength converting material can be lowest at the light output boundary 234. The wavelength converting material density may be graded and may vary (e.g., decrease or increase) as a function of distance from the light output boundary (or equivalently, as a function of distance from the light source).

One or more different wavelength converting materials can be included in the illumination assembly. In some embodiments, the wavelength converting material includes a first wavelength converting material that can emit secondary light having a first dominant wavelength and a second wavelength converting material that can emit secondary light having a second dominant wavelength different from the first dominant wavelength. The first wavelength converting material can be disposed in the optical path between the lambertian device and the second wavelength converting material. The first dominant wavelength can be larger than the second dominant wavelength. In other embodiments, the first dominant wavelength can be smaller than the second dominant wavelength. A wavelength filter can be disposed in the optical path between the first and the second wavelength converting materials, and configured to reflect light emitted by the second wavelength converting material and transmit light emitted by the first wavelength material and the lambertian device.

FIG. 2B illustrates a lambertian device 200b, in accordance with one embodiment. The light emitting device can include light emitting diode 131 with light emitting surface 138. The diode can be connected via wire bonds 222 to the contact pad 226, which placed on the insulating layer 224. The light emitting device 200b may contain a driver/power converter 210 that contains inputs into the driver 212 and 214 and driver connections 216 and 218. The driver/power converter can allow control of the light emitting device 200b through electrical inputs 212 and 214. The driver/power converter is connected to contact pad 226 and the heat sink 206.

A driver can be a power source or power component which can regulate and provide power to one or more light emitting devices. The driver can provide a power signal to one or more light emitting devices, wherein the power signal may have any suitable waveform, including, but not limited to, a pulsed or continuous waveform. Electrical power supplied to one or more light emitting devices may be varied by modifying the duty cycle of the power signal and/or the amplitude of the power signal. In some embodiments, the duty cycle of a pulsed power signal provided to one or more Light emitting devices may be varied by modifying the frequency of the pulses, the width of the pulses, and/or the amplitude of the pulses. A pulsed signal allows the light emitting device to be operated at a desired duty cycle (e.g., 75% duty cycle, meaning the light emitting device is “on” 75% of the time). This is in contrast to a duty cycle of 100% or a continuous “on” state. The pulses or on/off times can be switched fast enough (e.g., on the order of about microseconds) that the human eye may interpret the light emitting device as being “on” constantly.

In some embodiments, light-emitting device can include a heat sink 206 with heat sink fins 208, which is attached to the copper core 220. Various embodiments of light-emitting devices including a heat sink can enable the dissipation of more than 20 W (e.g., more than 10 W, more than 25 W, more than 50 W) of heat from the light-emitting die. The ability to extract such large amounts of heat can facilitate the use of high power light-emitting devices which typically generate significant thermal energy during operation.

Any suitable external heat sink may be used. The heat sink can include passive and/or active heat exchanging mechanisms, as the invention is not limited in this respect. Passive heat sinks can include structures formed of one or more materials that conduct heat as a result of temperature differences in the structure. Passive heat sinks may also include protrusions 208 (e.g., fins, combs, spikes, etc.) which can increase the surface contact area with the surrounding ambient and therefore facilitate heat exchange with the ambient. For example, a passive heat sink may include a copper slug core 220, which provides a thermally conductive material that can conduct thermal energy to surrounding aluminum fins radiating out from the copper slug. In a further embodiment, a passive heat sink may also include channels in which fluid (e.g., liquid and/or gas) may flow so as to aid in heat extraction via convection within the fluid. For example, in one embodiment, the heat sink may comprise a heat pipe to facilitate heat removal. Suitable heat pipes are available from such vendors as Lightstream Photonics and Furukawa America, but it should be understood that the embodiments presented herein are not limited to merely such examples of heat pipes. Heat pipes can be designed to have any suitable shape, and are not necessarily limited to only cylindrical shapes. Other heat pipe shapes may include rectangular shapes which may have any desired dimensions.

In certain embodiments, the light emitting device may emit light having high power. As described in more detail below, the high power of emitted light may be a result of a pattern that influences the light extraction efficiency of the light emitting device. For example, the light emitted by the light emitting device may have a total power greater than 0.5 Watts (e.g., greater than 1 Watt, greater than 5 Watts, or greater than 10 Watts). In some embodiments, the light generated has a total power of less than 100 Watts, though this should not be construed as a limitation of all embodiments. The total power of the light emitted from a light emitting device can be measured by using an integrating sphere equipped with spectrometer, for example a SLM12 from Sphere Optics Lab Systems. The desired power depends, in part, on the optical system that the light emitting device is being utilized within. For example, a general solid state lighting system may benefit from the incorporation of single high brightness light emitting device which can eliminate the need for multiple Light emitting devices that are used to in conventional general solid state lighting systems.

The light generated by the light emitting device may also have a high total power flux. As used herein, the term “total power flux” refers to the total power divided by the emission area. In some embodiments, the total power flux is greater than 0.03 Watts/mm², greater than 0.05 Watts/mm², greater than 0.1 Watts/mm², or greater than 0.2 Watts/mm². However, it should be understood that the light emitting devices used in systems and methods presented herein are not limited to the above-described power and power flux values.

In some embodiments, the illumination assembly 200a can serve as a light source for general illumination. In such an embodiment, the illumination assembly can equally distribute substantially the same intensity of light through a volume of space. In this embodiment the light source is intended to replace single florescent and single incandescent light sources with a single light source. In this embodiment, the light-emitting device may emit white light.

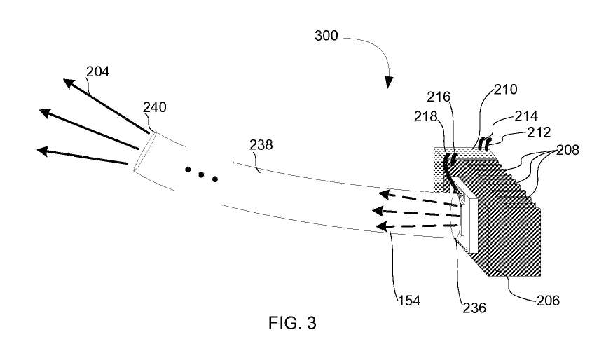

FIG. 3 illustrates a perspective view of an optical illumination routing assembly that emits light remotely from the light emitting device, in accordance with one embodiment. An optical illumination routing assembly allows for light to be routed to a remote location from the original light source. The routed light it outputted through a light output port, a distance away from the original light source. Any embodiment of an optical illumination routing assembly will have at least one light output port to which light is routed.

In one embodiment, the assembly contains a light guide 238. The light guide 238 contains a light input end 236 and a light output end 240. The light emitted out of the light emitting device 154 is received through the light input end 236 and travels through the light guide 238 until it is re-emitted as light 204 at the light output end 240. Light output end 240 corresponds to a light output port of an optical illumination routing assembly. Re-emitted light 204 is comprised of at least a portion of the light 154 that entered the light guide 238. The assembly 300 is configured so that the portion of light 204 at light end 240 is substantially the same amount of light as the amount that entered the light guide at 236.

In one embodiment, the light guide is cylindrical in shape (e.g., rod with a circular or elliptical cross-section). However, the light guide may comprise other light guiding shapes suitable to deliver substantially the same amount of light remotely from the light emitting source. In a preferred embodiment, the cylindrical guide is comprised of an optical fiber which may be formed of an optically transparent material glass or a plastic material (e.g., acrylic, PMMA). In some embodiments, the optical fiber may be flexible so that it may be bent to a desired configuration. In some embodiments, the optical fiber may comprise a light pipe. A typical light pipe may contain a solid core fiber and is surrounded a cladding layer and a shielding layer.

In some embodiments, the illumination assembly can emit light of a single color. For example, the light-emitting device may be a red, green, blue, yellow, and/or cyan light-emitting device. In other embodiments, the light-emitting device is a multi-colored light-emitting device that emits light having a spectrum of wavelengths. For example, the light-emitting device may be a red-green-blue light-emitting device. In other embodiments, the light-emitting device may be a red-green-blue-yellow light-emitting device. In yet other embodiments, the light-emitting device may be a red-green-blue-cyan light-emitting device. In yet other embodiments, the light-emitting device is a red-green-blue-cyan-yellow light-emitting device. Illumination assemblies can also include combinations of light-emitting device types such as the ones described above. Of course, light-emitting devices of different colors can also be used in embodiments.

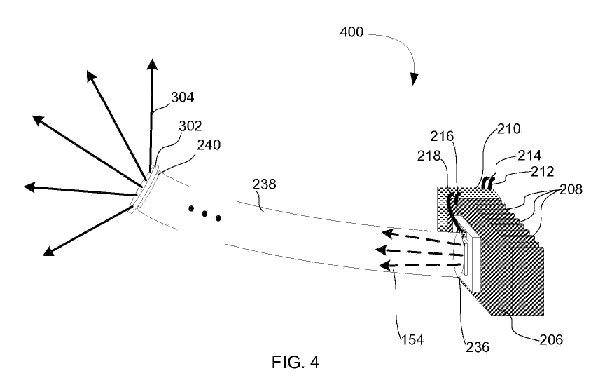

FIG. 4 illustrates a perspective view of an optical illumination routing assembly that includes wavelength converting material at the light output end of the cylindrical light guide, in accordance with one embodiment. Some or all of the light emitted out of light output end 240 having a first wavelength may be absorbed by the wavelength converting material 302 and emitted as light having a second different wavelength 304.

In one embodiment, the wavelength converting material may comprise a component coated with a phosphor material. In some embodiments, the wavelength converting material components may be of any suitable shape. In one embodiment, the components may be a thin disk shape that is substantially the same radius as the light output end of the cylindrical light guide.

In some embodiments, the phosphor material may be present in particulate form. The wavelength converting material regions may be formed by a number of methods. Such methods include printing, molding (e.g., injection molding), coating, spraying, and/or embossing may be employed. For example, a printing process (e.g., a jet printing process) may be used to create wavelength converting material having a spatially varying density (e.g., per unit area of the emission surface of the illumination assembly). The printer cartridge may include a solution comprising the wavelength converting material (e.g., phosphor and/or quantum dots). Varying thickness of a wavelength converting material region can then be created by performing a longer printing step at different locations. Alternatively, or additionally, small features (e.g., dots, stripes) with small sizes (e.g., less than 500 microns, less than 200 microns, less than 100 microns) can be printed with a spatially varying nearest neighbor distance. In other embodiments, wavelength converting material may be included in a molding material (e.g., a polymer such as PMMA or acrylic) so as to have a varying density at different locations of the molded component, such as a molded light guide. The particles may be distributed in a second material (e.g., an encapsulant or adhesive, such as epoxy) to form a composite structure or a plate. In another embodiment, the wavelength converting material may be a polycrystalline or a single crystalline phosphor material. In yet another embodiment, quantum dots instead of phosphors can also serve as wavelength converting materials.

Any suitable phosphor material or a combination of phosphor materials may be used. In some embodiments, the phosphor material can be formed of a (Y,Gd)(Al,Ga)G:Ce³⁺ or “YAG” (yttrium aluminum garnet) phosphor, a Tb₃ Al₅O₁₂:Ce³⁺ or “TAG” (terbium aluminum garnet) or a silicate-based phosphor material. When pumped by blue light emitted from the light-generating region, the phosphor material can be activated and emit light (e.g., isotropically) with a broad spectrum centered around yellow wavelengths. A viewer of the total light spectrum emerging from the light emitting device sees the yellow phosphor broad emission spectrum and the blue InGaN narrow emission spectrum and typically mixes the two spectra to perceive white.

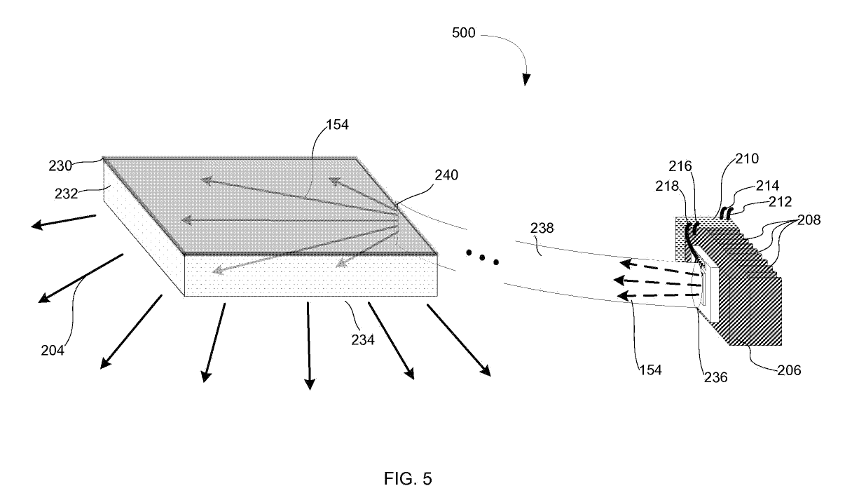

FIG. 5 illustrates a perspective view of an optical illumination routing assembly that includes a cylindrical light guide that remotely lights a light guide, in accordance with one embodiment. Placing the light emitting device remotely from the illumination assembly can allow for more flexible and space saving general lighting designs.

Some or all of the light 154 outputted by the light emitting device may be transmitted to a light guide comprised of the luminaire 232 of FIG. 2A. The light guide 232 is coupled to the cylindrical light guide by output end 240. The emission surface of the light guide may be substantially perpendicular to the general direction of the light 204 leaving the light guide 232. Alternatively or additionally the light 204 leaving the second light guide may be at any angle in relation to the light emission surface.

The light guide 232 can include light extraction features that can scatter light out via the light emission surface 234. The light guide 232 may include one or more components composed of material(s) that can transmit, diffuse, homogenize, and/or emit some or all of the light transmitted therein. In some embodiments, the light guide 232 may include scattering centers that can diffuse, scatter, homogenize, and/or emit some or all of the light transmitted therein so that light may exit along some or all of the length of the second light guide 232. The light guide 232 may contain a reflective layer 230 that can reflect light downward and away from the top surface of the light guide. In some embodiments, the light guide 232 can be configured and arranged such that light emission from the emission surface 234 has a substantially uniform (e.g., less than about 20% variation, less than about 15% variation, less than about 10% variation) light intensity across the emission surface 234. In some embodiments, the light guide 232 may contain multiple emission surfaces 234.

In some embodiments, a wavelength converting material is at least partially disposed within the light guide. The wavelength converting material may be located within part or all of the light guide such that some or all of the primary light from light-emitting device 154 may be wavelength converted within the light guide. In some embodiments, the wavelength converting material may be a layer disposed over the reflective surface 230. Additionally or alternatively the wavelength converting material may be a layer disposed over the light extraction surface 234.

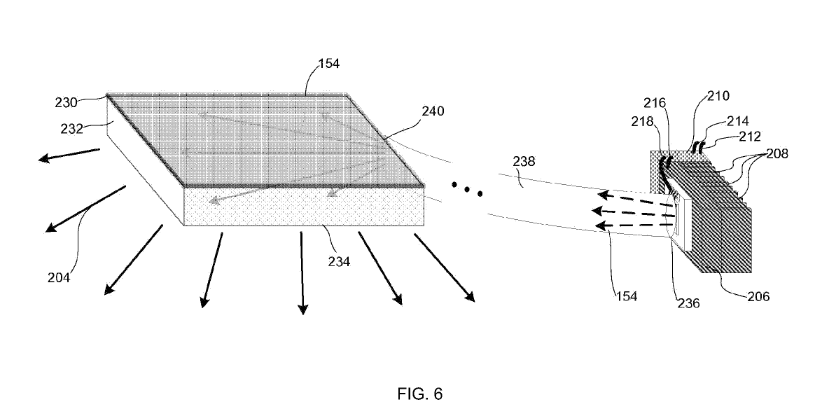

In some embodiments, an illumination assembly can serve as a backlight unit for an ultra-thin display, where the light source is remotely located from the display. One such embodiment is illustrated in the perspective view of FIG. 6. Placing the light source, electronic control systems, and heat dissipation elements remotely from the screen may allow the display to be ultra thin and to be wall-hung. The ultra-thin display panel and the light-emitting device may be positioned vertically. The light-emitting device may be located some distance away (e.g., more than about 1 meter away, more than about 2 meters, more than 3 meters). The light emitting device and the cylindrical light guide may be hidden from view, while the light guide panel may be attached to the ultra-thin display.

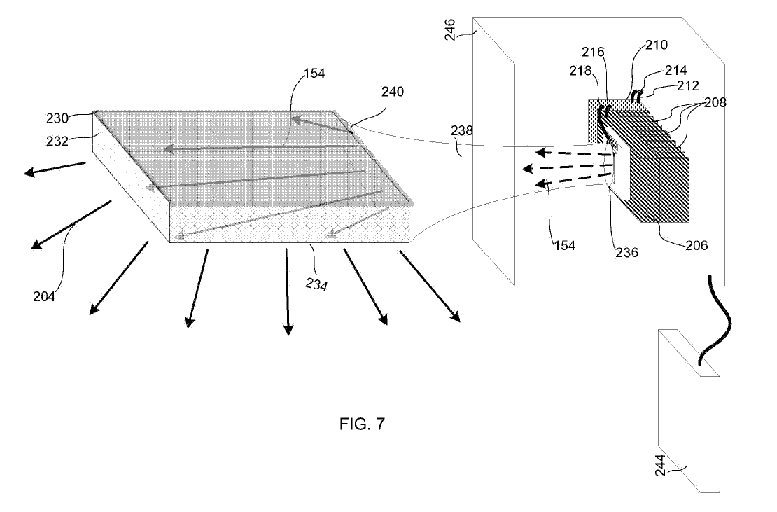

In other embodiments, an illumination assembly can serve as an ultra-thin display panel for a computer. One such embodiment is illustrated in the perspective view of FIG. 7. The display base 246 may include the light source and the computer processing hardware. In such an embodiment, the light may be fanned by a spatial homogenizer 238 located within display base 246. A keyboard 244, or other input out or output devices, may be attached to the display base 246 that may be used to interact with the computer processing hardware within the display base 246. In some embodiments, the spatial homogenizer 238 may comprise a light guide. The light guide may contain a light input end 236 and a light output end 240. The light input end 236 may be sufficiently large to accept light 154 emitted out of the light-emitting device. The light output end 240 may be sufficiently large to couple to the ultra-thin display panel. The light guide 238 may fan light 154 by gradually increasing, in two points of an elliptical radius, from the light input end to the light output end in order to couple to the ultra-thin display panel.

In some embodiments, one or more layers 230 of the display may be illuminated by the illumination assembly. Layer(s) 230 may include a liquid crystal light valve layer (corresponding to the liquid crystal light-valve pixels of the display). The illumination assembly can thus serve as a backlighting assembly for the liquid crystal display layer and light 154 from the illumination assembly can impinge on the liquid crystal display layer.

Other layers often used in LCDs, such as diffuser layers, brightness enhancement films (BEFs), and/or color filters may be located over the light emission surface of the illumination assembly. In addition to display backlighting, the illumination assembly can be used for illumination purposes, including but not limited to, signage backlighting, outdoor lighting, indoor lighting, automotive lighting, and other lighting applications. For a general lighting assembly, the illumination assembly can be used as is or may have other layers disposed over the emission surface of the assembly, for example one or more layers may be located over the assembly so as to alter the lightening character. For example, a textured or patterned layer or optic (e.g., a polymer and/or glass component) may be placed over the assembly.

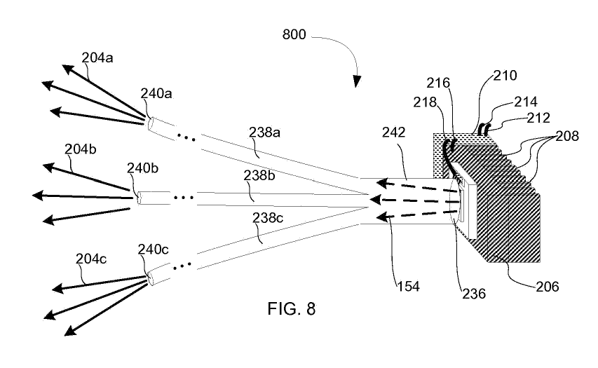

FIG. 8 illustrates a perspective view of an optical illumination routing assembly that includes multiple cylindrical light guides, in accordance with one embodiment. The illumination assembly shown in FIG. 8 can include a single lambertian surface emitting device which may include a light-emitting diodes and/or laser diodes. Light 154 outputted by the light emitting device may be coupled to a cylindrical light guide with one light input end 236 and multiple light output ends 240a, 240b, 240c. Light 154 is split between cylindrical multiple light guides 238a, 238b, 238c that are coupled to the single cylindrical light guide 242 and is emitted separately as light 204a, 204b, 204c. In one embodiment, light 204a, 204b, 204c may be the same matched wavelength. In another embodiment, light 204a, 204b, 204c may each be a different wavelength. Multiple light output ends 240a, 240b, 240c may be configured to output combined light 204a, 204b, 204c to be substantially the same amount of light as light 154 out of the light emitting device.

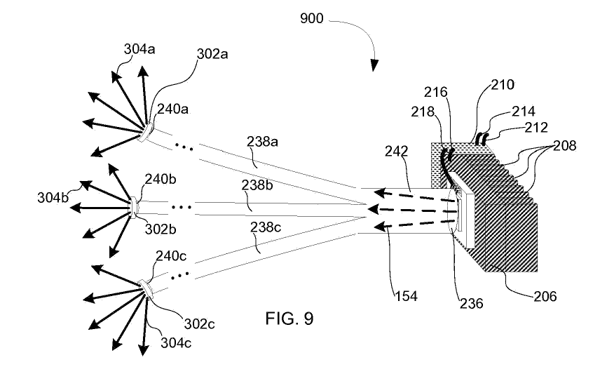

FIG. 9 illustrates a perspective view of an optical illumination routing assembly that includes wavelength converting material at each of the light output ends of the multiple cylindrical light guides, in accordance with one embodiment. Some or all of the light emitted out of light output ends 240a, 240b, 240c having a first wavelength may be absorbed by the wavelength converting materials 302a, 302b, 302c and emitted as light having a second different wavelength 304a, 304b, 304c. In one embodiment, each of the wavelength converting materials 302a, 302b, 302c may be the same and may emit the same second wavelengths 304a, 304b, 304c. Alternatively, each of the wavelength converting materials 302a, 302b, 302c may be different and may emit different second wavelengths 304a, 304b, 304c.

In one embodiment, the wavelength converting material may comprise plates coated with a phosphor material. In another embodiment, the phosphor material may be present in particulate form. Phosphors can be applied by various techniques comprising spraying, stenciling, spin-on glass, electroforming, spin coating, injection molding, and thin layer deposition. The particles may be distributed in a second material (e.g., an encapsulant or adhesive, such as epoxy) to form a composite structure or a plate. In another embodiment, the wavelength converting material may be a polycrystalline or a single crystalline phosphor material. In yet another embodiment, quantum dots instead of phosphors can also serve as wavelength converting materials. Any suitable phosphor material or a combination of phosphor materials may be used. In some embodiments, the phosphor material is a YAG, TAG or a silicate-based phosphor material.

In some embodiments, the wavelength converting material plates may be of any suitable shape. In one embodiment, the plates can be a thin disk shape that is substantially the same radius as the light output end of the cylindrical light guide. In one embodiment, the plates have substantially similar shape and can be configured to be interchangeable between the multiple output ends 240a, 240b, 240c. Interchanging the plates between the multiple output ends may allow for a customization of light color at each output end. The light of different color at each output end can mix together to produce different lighting effect.

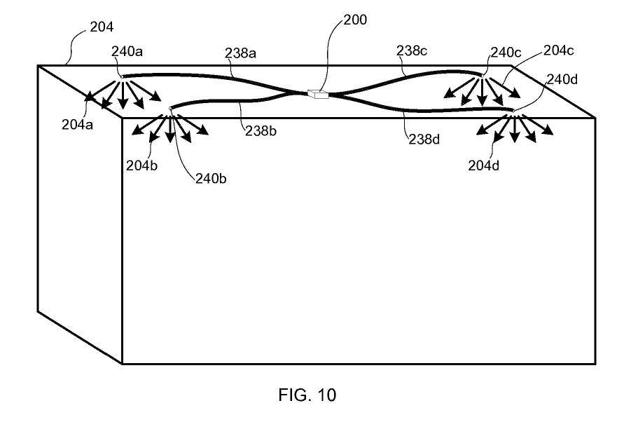

FIG. 10 illustrates a perspective view of an optical illumination routing assembly that includes multiple cylindrical light guides arranged to substantially illuminate a maximized volume of space, in accordance with one embodiment. Light-emitting device 200 may be coupled to cylindrical multiple light guides 238a, 238b, 238c, 238d, which may have separate light output ends 240a, 240b, 240c, 240d. Light emitted out the light-emitting device 200 may be split between cylindrical multiple light guides 238a, 238b, 238c, 238d and may be emitted separately as light 204a, 204b, 204c, 240d. Separately emitted light 204a, 204b, 204c, 240d can substantially illuminate a volume of space 204. Volume of space 204, illuminated by the general lighting assembly, can be much greater than the volume of space that a single light-emitting device 200 can illuminate. The light emission volume 204 may be greater than about 10 m³ (e.g., greater than or equal to about 15 m³, greater than or equal to about 25 m³, greater than or equal to about 35 m³). However, it should be understood that the emission volume of space that the general lighting assembly can illuminate herein is not limited to the above-described volume figures. It should also be appreciated that the lighting assembly herein is not limited to the number of light guides, light output ports or the configuration shown.

The multiple cylindrical light guides of the general lighting assembly can be arranged to maximize the volume of space that the assembly can illuminate. In some embodiments, the light output ends are placed at such a distance away from the light-emitting device 200 that the light out of the device does not reduce in intensity (i.e. the light intensity out of the light-emitting device is substantially the same as the light intensity out the light output ends) and the light within the volume of space is substantially uniform in all locations within the volume. In some embodiments, the light output ends may be equidistant from each other and the light emitting device. In other embodiments, the light output ends may be closer to other light output ends and further away from the light emitting device. It should be appreciated that any number of light guides with light output ports may be used to create any configuration that substantially illuminates a maximized volume of space.

In some embodiments, different light intensities within the volume of space may be needed. Building codes can limit lighting to specific light power per square meter. These are average figures that can vary based on what task needs to be performed. For example, a storage room might require lower lighting levels and an office area might require higher lighting levels than average. These average levels can be exceeded or reduced in order to providing sufficient light for effective human performance.

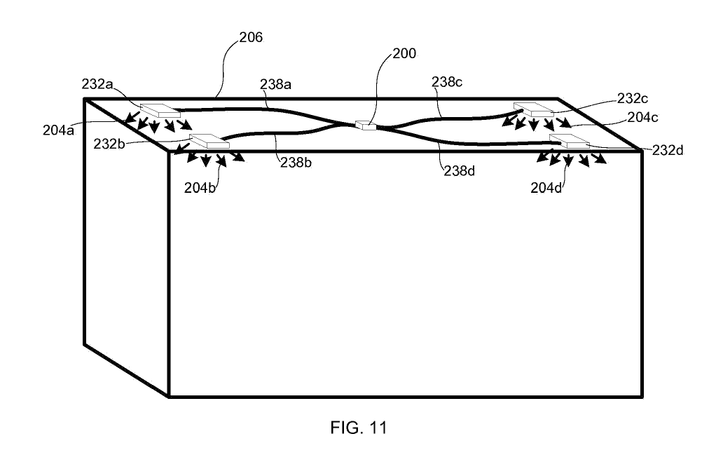

FIG. 11 illustrates a perspective view of an optical illumination routing assembly that includes second light guides at each of the light output end of the multiple cylindrical light guides arranged as in FIG. 10, in accordance with one embodiment. Light-emitting device 200 may be coupled to cylindrical multiple light guides 238a, 238b, 238c, 238d, which may have separate light output ends 240a, 240b, 240c, 240d. Separate light output ends 240a, 240b, 240c, 240d may be coupled to second light guides 232a, 232b, 232c, 232d. Light emitted out the light-emitting device 200 may be split between cylindrical multiple light guides 238a, 238b, 238c, 238d and may be emitted separately as light 204a, 204b, 204c, 240d out of the second light guides.

Separately emitted light 204a, 204b, 204c, 240d can substantially illuminate a volume of space 206. Volume of space 206, illuminated by the optical illumination routing assembly, can be much greater than the volume of space that a single light-emitting device 200 can illuminate or be much greater than the volume of space that a light assembly of FIG. 10 can illuminate. The light emission volume 206 may be greater than about 10 m³ (e.g., greater than or equal to about 15 m³, greater than or equal to about 25 m³, greater than or equal to about 35 m³). However, it should be understood that the emission volume of space that the general lighting assembly can illuminate herein is not limited to the above-described volume figures. It should also be appreciated that the lighting assembly herein is not limited to the number of light guides or the light output ports.

Light guides 232a, 232b, 232c, 232d may have light extraction properties. Light extraction properties may include one or more components in the second light guides composed of material(s) that can transmit, diffuse, homogenize, and/or emit some or all of the light transmitted therein. In some embodiments, Second light guides may include scattering centers that can diffuse, scatter, homogenize, and/or emit some or all of the light transmitted therein so that light may exit along some or all of the length of the second light guides.

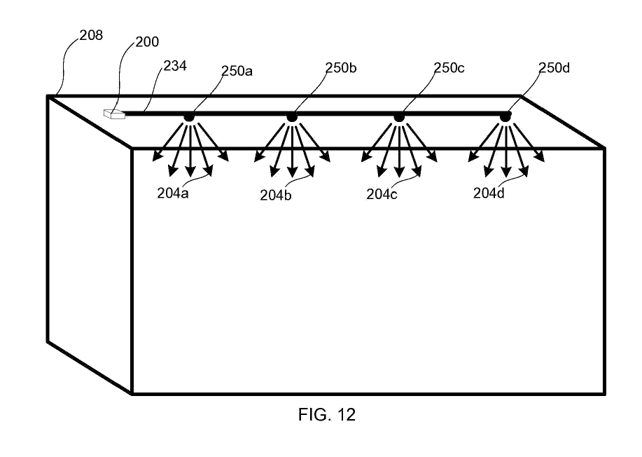

FIG. 12 a perspective view of an optical illumination routing assembly that is part of a general lighting assembly and includes light output ports arranged linearly, in accordance with one embodiment. In one embodiment, the general lighting assembly contains multiple light output ports 250a, 250b, 250c, 250d, arranged linearly along the length of a long light guide 234. The multiple light output ports 250a, 250b, 250c, 250d can be configured to output a portion of the light emitted by a light-emitting device 200. In one embodiment, a portion of the light 204a, 204b, 204c, 204d emitted by the multiple light output ports 250a, 250b, 250c, 250d aggregated together can be substantially the same as the light emitted by the light emitting device 200. In some embodiments, the general lighting assembly can be configured to substantially illuminate a volume of space 208. The light emission volume 208 may be greater than about 10 m³ (e.g., greater than or equal to about 15 m³, greater than or equal to about 25 m³, greater than or equal to about 35 m³). However, it should be understood that the emission volume of space that the general lighting assembly can illuminate herein is not limited to the above-described volume figures. It should also be appreciated that the lighting assembly herein is not limited to the number of light guides or the number of light output ports.

The optical illumination routing assembly of FIG. 12 can allow for efficient conversion of propagating light into downward refracted light for illumination purposes. In some embodiments, the multiple light output ports 250a, 250b, 250c, 250d can be light scattering centers which may be created by variations in the surface of the light guide 234. Light emitted by light emitting device 200 can travel through the length of the light guide 234 and can be scattered or extracted when the light reaches the scattering centers. In some embodiments, the scattering centers can be light extraction microlenses.

In other embodiments, surface variations can be regions of wavelength converting material of different density. These regions of different density may be located throughout the light guide 234 or located only where light would need to be extracted. Examples of regions of different density are provided in U.S. patent application Ser. No. 11/831,267, entitled “Illumination Assembly including Wavelength Converting Material,” filed on Jul. 31, 2007, which is herein incorporated by reference in its entirety.

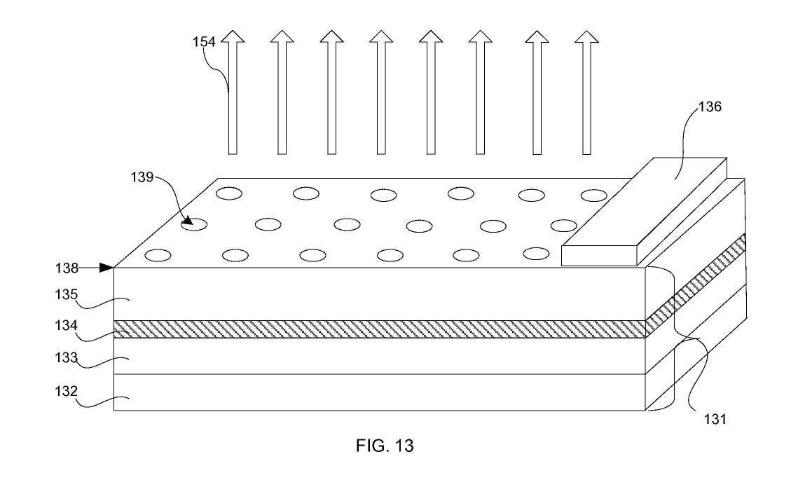

In some embodiments, the light-emitting devices in the illumination assemblies presented herein can include a light-emitting diode. The light-emitting device (e.g., light-emitting diode) may be a solid-state device. The light-emitting device (e.g., light-emitting diode) may be semiconductor-based. For example, the light-emitting device (e.g., light-emitting diode) may comprise a III-V semiconductor. FIG. 13 illustrates a light-emitting diode (LED) which may be one example of a light-emitting device, in accordance with one embodiment. Suitable LEDs have been described in U.S. Pat. No. 6,831,302 which is incorporated herein by reference in its entirety. It should be understood that various embodiments presented herein can also be applied to other light-emitting devices, such as laser diodes, and LEDs having different structures (such as organic LEDs, also referred to as OLEDs). LED 1600 shown in FIG. 13 comprises a multi-layer stack 31 that may be disposed on a support structure (not shown). The multi-layer stack 31 can include an active region 34 which is formed between n-doped layer(s) 35 and p-doped layer(s) 33. The stack can also include an electrically conductive layer 32 which may serve as a p-side contact, which can also serve as an optically reflective layer. An n-side contact pad 36 may be disposed on layer 35. Electrically conductive fingers (not shown) may extend from the contact pad 36 and along the surface 38, thereby allowing for uniform current injection into the LED structure.

It should be appreciated that the LED is not limited to the configuration shown in FIG. 13, for example, the n-doped and p-doped sides may be interchanged so as to form a LED having a p-doped region in contact with the contact pad 36 and an n-doped region in contact with layer 32. As described further below, electrical potential may be applied to the contact pads which can result in light generation within active region 34 and emission (represented by arrows 152) of at least some of the light generated through an emission surface 38. As described further below, holes 39 may be defined in an emission surface to form a pattern that can influence light emission characteristics, such as light extraction and/or light collimation. It should be understood that other modifications can be made to the representative LED structure presented, and that embodiments are not limited in this respect.

The active region of an LED can include one or more quantum wells surrounded by barrier layers. The quantum well structure may be defined by a semiconductor material layer (e.g., in a single quantum well), or more than one semiconductor material layers (e.g., in multiple quantum wells), with a smaller electronic band gap as compared to the barrier layers. Suitable semiconductor material layers for the quantum well structures can include InGaN, AlGaN, GaN and combinations of these layers (e.g., alternating InGaN/GaN layers, where a GaN layer serves as a barrier layer). In general, LEDs can include an active region comprising one or more semiconductors materials, including III-V semiconductors (e.g., GaAs, AlGaAs, AlGaP, GaP, GaAsP, InGaAs, InAs, InP, GaN, InGaN, InGaAlP, AlGaN, as well as combinations and alloys thereof), II-VI semiconductors (e.g., ZnSe, CdSe, ZnCdSe, ZnTe, ZnTeSe, ZnS, ZnSSe, as well as combinations and alloys thereof), and/or other semiconductors. Other light-emitting materials are possible such as quantum dots or organic light-emission layers.

The n-doped layer(s) 35 can include a silicon-doped GaN layer (e.g., having a thickness of about 4000 nm thick) and/or the p-doped layer(s) 33 include a magnesium-doped GaN layer (e.g., having a thickness of about 40 nm thick). The electrically conductive layer 32 may be a silver layer (e.g., having a thickness of about 100 nm), which may also serve as a reflective layer (e.g., that reflects upwards any downward propagating light generated by the active region 34). Furthermore, although not shown, other layers may also be included in the LED; for example, an AlGaN layer may be disposed between the active region 34 and the p-doped layer(s) 33. It should be understood that compositions other than those described herein may also be suitable for the layers of the LED.

As a result of holes 39, the LED can have a dielectric function that varies spatially according to a pattern. Typical hole sizes can be less than about one micron (e.g., less than about 750 nm, less than about 500 nm, less than about 250 nm) and typical nearest neighbor distances between holes can be less than about one micron (e.g., less than about 750 nm, less than about 500 nm, less than about 250 nm). Furthermore, as illustrated in the figure, the holes 39 can be non-concentric.

The dielectric function that varies spatially according to a pattern can influence the extraction efficiency and/or collimation of light emitted by the LED. In some embodiments, a layer of the LED may have a dielectric function that varies spatially according to a pattern. In the illustrative LED 1600, the pattern is formed of holes, but it should be appreciated that the variation of the dielectric function at an interface need not necessarily result from holes. Any suitable way of producing a variation in dielectric function according to a pattern may be used. For example, the pattern may be formed by varying the composition of layer 35 and/or emission surface 38. The pattern may be periodic (e.g., having a simple repeat cell, or having a complex repeat super-cell), or non-periodic. As referred to herein, a complex periodic pattern is a pattern that has more than one feature in each unit cell that repeats in a periodic fashion. Examples of complex periodic patterns include honeycomb patterns, honeycomb base patterns, (2×2) base patterns, ring patterns, and Archimedean patterns. In some embodiments, a complex periodic pattern can have certain holes with one diameter and other holes with a smaller diameter. As referred to herein, a non-periodic pattern is a pattern that has no translational symmetry over a unit cell that has a length that is at least 50 times the peak wavelength of light generated by one or more light-generating portions. As used herein, peak wavelength refers to the wavelength having a maximum light intensity, for example, as measured using a spectroradiometer. Examples of non-periodic patterns include aperiodic patterns, quasi-crystalline patterns (e.g., quasi-crystal patterns having 8-fold symmetry), Robinson patterns, and Amman patterns. A non-periodic pattern can also include a detuned pattern (as described in U.S. Pat. No. 6,831,302 by Erchak, et al., which is incorporated herein by reference in its entirety). In some embodiments, a device may include a roughened surface. The surface roughness may have, for example, a root-mean-square (rms) roughness about equal to an average feature size which may be related to the wavelength of the emitted light.

In certain embodiments, an interface of a light-emitting device is patterned with holes which can form a photonic lattice. Suitable LEDs having a dielectric function that varies spatially (e.g., a photonic lattice) have been described in, for example, U.S. Pat. No. 6,831,302 B2, entitled “Light emitting devices with improved extraction efficiency,” filed on Nov. 26, 2003, which is herein incorporated by reference in its entirety. A high extraction efficiency for an LED implies a high power of the emitted light and hence high brightness which may be desirable in various optical systems.

It should also be understood that other patterns are also possible, including a pattern that conforms to a transformation of a precursor pattern according to a mathematical function, including, but not limited to an angular displacement transformation. The pattern may also include a portion of a transformed pattern, including, but not limited to, a pattern that conforms to an angular displacement transformation. The pattern can also include regions having patterns that are related to each other by a rotation. A variety of such patterns are described in U.S. Patent Publication No. 20070085098, entitled “Patterned devices and related methods,” filed on Mar. 7, 2006, which is herein incorporated by reference in its entirety.

Light may be generated by the LED as follows. The p-side contact layer can be held at a positive potential relative to the n-side contact pad, which causes electrical current to be injected into the LED. As the electrical current passes through the active region, electrons from n-doped layer(s) can combine in the active region with holes from p-doped layer(s), which can cause the active region to generate light. The active region can contain a multitude of point dipole radiation sources that generate light with a spectrum of wavelengths characteristic of the material from which the active region is formed. For InGaN/GaN quantum wells, the spectrum of wavelengths of light generated by the light-generating region can have a peak wavelength of about 445 nanometers (nm) and a full width at half maximum (FWHM) of about 30 nm, which is perceived by human eyes as blue light. The light emitted by the LED may be influenced by any patterned surface through which light passes, whereby the pattern can be arranged so as to influence light extraction and/or collimation.

In other embodiments, the active region can generate light having a peak wavelength corresponding to ultraviolet light (e.g., having a peak wavelength of about 370-390 nm), violet light (e.g., having a peak wavelength of about 390-430 nm), blue light (e.g., having a peak wavelength of about 430-480 nm), cyan light (e.g., having a peak wavelength of about 480-500 nm), green light (e.g., having a peak wavelength of about 500 to 550 nm), yellow-green (e.g., having a peak wavelength of about 550-575 nm), yellow light (e.g., having a peak wavelength of about 575-595 nm), amber light (e.g., having a peak wavelength of about 595-605 nm), orange light (e.g., having a peak wavelength of about 605-620 nm), red light (e.g., having a peak wavelength of about 620-700 nm), and/or infrared light (e.g., having a peak wavelength of about 700-1200 nm).

In certain embodiments, the LED may emit light having a high light output power. As previously described, the high power of emitted light may be a result of a pattern that influences the light extraction efficiency of the LED. For example, the light emitted by the LED may have a total power greater than 0.5 Watts (e.g., greater than 1 Watt, greater than 5 Watts, or greater than 10 Watts). In some embodiments, the light generated has a total power of less than 100 Watts, though this should not be construed as a limitation of all embodiments. The total power of the light emitted from an LED can be measured by using an integrating sphere equipped with spectrometer, for example a SLM12 from Sphere Optics Lab Systems. The desired power depends, in part, on the optical system that the LED is being utilized within. For example, a display system (e.g., a LCD system) may benefit from the incorporation of high brightness LEDs which can reduce the total number of LEDs that are used to illuminate the display system.

The light generated by the LED may also have a high total power flux. As used herein, the term “total power flux” refers to the total optical power divided by the emission area. In some embodiments, the total power flux is greater than 0.03 Watts/mm², greater than 0.05 Watts/mm², greater than 0.1 Watts/mm², or greater than 0.2 Watts/mm². However, it should be understood that the LEDs used in systems and methods presented herein are not limited to the above-described power and power flux values.

In some embodiments, the LED may be associated with one or more wavelength converting regions. The wavelength converting region(s) may include one or more phosphors and/or quantum dots. The wavelength converting region(s) can absorb light emitted by the light-generating region of the LED and emit light having a different wavelength than that absorbed. In this manner, LEDs can emit light of wavelength(s) (and, thus, color) that may not be readily obtainable from LEDs that do not include wavelength converting regions. In some embodiments, one or more wavelength converting regions may be disposed over (e.g., directly on) the emission surface (e.g., surface 38) of the light-emitting device.

As used herein, an LED may be an LED die, a partially packaged LED die, or a fully packaged LED die. It should be understood that an LED may include two or more LED dies associated with one another, for example a red light-emitting LED die, a green light-emitting LED die, a blue light-emitting LED die, a cyan light-emitting LED die, or a yellow light-emitting LED die. For example, the two or more associated LED dies may be mounted on a common package. The two or more LED dies may be associated such that their respective light emissions may be combined to produce a desired spectral emission. The two or more LED dies may also be electrically associated with one another (e.g., connected to a common ground).

As used herein, when a structure (e.g., layer, region) is referred to as being “on”, “over” “overlying” or “supported by” another structure, it can be directly on the structure, or an intervening structure (e.g., layer, region) also may be present. A structure that is “directly on” or “in contact with” another structure means that no intervening structure is present.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A general lighting assembly comprising:
a semiconductor-based light-emitting device; and
a luminaire separated from and in optical communication with the light-emitting device configured to receive and to transmit light emitted by the light-emitting device to an emission surface of the luminaire through which light is emitted.

2-3. (canceled)

4. The assembly of claim 1, wherein the light-emitting device has a light emission surface greater than one square millimeter.

5. The assembly of claim 1, wherein the luminaire includes an edge configured to receive the light emitted by the light-emitting device.

6. (canceled)

7. The assembly of claim 1, wherein a distance between a light emission surface of the light-emitting device and the emission surface of the luminaire is at least 15 inches.

8-10. (canceled)

11. The assembly of claim 1, wherein the assembly is configured to illuminate a volume of space greater than 10 m³.

12. (canceled)

13. The assembly of claim 1, wherein a wavelength converting material is disposed within the luminaire.

14. The assembly of claim 1, wherein the luminaire includes a backside surface opposing a light extraction surface, and wherein a reflective layer is at least partially disposed on the backside surface.

15. The assembly of claim 1, wherein the reflective layer is configured to reflect light away from the backside surface.

16. The assembly of claim 1, wherein the luminaire is a light guide.

17-19. (canceled)

20. The assembly of claim 1, wherein a light emission surface of the light-emitting device is in contact with a light receiving surface of the luminaire.

21. (canceled)

22. An optical illumination routing assembly comprising:
at least one separate light output port configured to output a portion of the light emitted by a light-emitting device, wherein the output port is located remotely from the light-emitting device.

23. The illumination routing assembly of claim 22, further comprising a light guide including a light input end configured to receive some portion of the light emitted by the light-emitting device and at least one light output end corresponding to at least one separate light output port.

24. The illumination routing assembly of claim 23, wherein the plurality of light output ends are located remotely from the light emitting device and configured to substantially illuminate a volume of space greater than 10 m3.

25-26. (canceled)

27. The illumination routing assembly of claim 22, further comprising wavelength converting material components at each of the plurality of light output ends.

28-31. (canceled)

32. The illumination routing assembly of claim 23, further comprising light guides at each of the plurality of light output ends.

33. (canceled)

34. The illumination routing assembly of claim 32, wherein the light guides include light extraction features.

35-38. (canceled)

39. The illumination routing assembly of claim 38, wherein the surface variations further comprise light extraction microlenses or regions of wavelength converting material of different density.

40. A general lighting assembly comprising:
a light-emitting device, wherein the light-emitting device is a single light-emitting diode adapted to emit light having a total output power flux greater than 0.5 Watt/mm2 and is configured to substantially illuminate a volume of space greater than 10 m3.

41. A general lighting assembly comprising:
a light-emitting device, wherein the light-emitting device is a single light-emitting diode that has a light emission surface greater than one square millimeter and is configured to substantially illuminate a volume of space greater than 10 m3.

42. An illumination system for a computer display comprising:
a display base housing computer processing hardware and at least a single light-emitting device, wherein the display base projects light that remotely illuminates the computer display.

43-44. (canceled)
